(19) United States
(12) Patent Application Publication
(10) Pub. No.: US 2008/0056218 A1
(43) Pub. Date: Mar. 6, 2008

(54) METHOD FOR TRANSMITTING MULTI-FRAME HANDOVER OR ASSIGNMENT MESSAGES

(75) Inventors: CHARLES P. BINZEL, Bristol, WI (US); Jeffrey C. Smolinski, Schaumburg, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/468,164

(22) Filed: Aug. 29, 2006

(51) Int. Cl. H04B 7/216

(52) U.S. Cl. 370/342

(57) ABSTRACT

A GSM serving base station method (200) for transmitting multi-block handover or assignment messages transmits to a mobile station all the I frames of a multi-frame handover command message or a multi-frame assignment command message (210). If the base station does not receives acknowledgement from the mobile station for all the I frames of the final message (220), does not receive a message from the network indicating the mobile station has completed its handover (230), and has not exceeded the maximum number of retransmissions allowed (240), all unacknowledged I frames are cyclically retransmitted (210). The mobile station can either follow normal procedures for a multi-framing operation (300) or it can buffer any out-of-sequence I frames received (either in sequence or in order of receipt) and re-assemble the complete final message after all I frames have been received (400).

### FIELD OF THE DISCLOSURE

This disclosure relates generally to Layer 3 traffic channel handover or assignment of a mobile station in a GSM (Global System for Mobile communications) or GSM-based wireless communication system.

### BACKGROUND OF THE DISCLOSURE

According to GSM standards promulgated by the 3rd Generation Partnership Project (3GPP), when a traffic channel handover of a mobile station is deemed desirable by a network, the network sends a Layer 3 handover command message (for intercell handovers) or a Layer 3 assignment command message (for intracell handovers) to that mobile station providing information regarding handover parameters. In today's complex networks, where hopping list and adaptive multi-rate (AMR) parameters are required for a successful handover or assignment, handover commands and assignment commands can no longer be sent in a single Layer 2 (L2) I frame. This means that multiple I frames must be sent and acknowledged one at a time by the Data Link Layer 2 (L2). See 3GPP Technical Specification (TS) 04.06 Section 5.8.4, which states “The maximum number (k) of sequentially numbered I frames that may be outstanding (that is, unacknowledged) at any given time is a system parameter which shall not exceed 7. For data links with SAPI=0 or 3 (see clause 6), the value of k shall be k=1. The value of k for other values of SAPI is for further study.” Handover or assignment messages are sent over data links with a Service Access Point Identifier (SAPI)=0.

Additionally, 3GPP TS 04.06 Section 5.7.1 states “An N(S) sequence error exception condition occurs in the receiver when a valid I frame is received which contains an N(S) value which is not equal to the receive state variable V(R) at the receiver. The information field of all I frames while N(S) does not equal the receive state variable V(R) shall be discarded.” Thus, current Section 5.7.1 requires each I frame of a multi-frame message to be received in sequence or else be discarded.

With the adoption of Repeated Downlink FACCH (fast associated control channel), the downlink from the serving cell to the mobile station often functions while the uplink from the mobile station to the serving cell does not function. Thus, the first downlink I frame of the handover command or assignment command is often transferred to the mobile station, but the acknowledgement of that first downlink I frame is not successfully transferred on the uplink. Because a next I frame of a multi-frame handover or assignment command message cannot be sent by the base station until the previous I frame is acknowledged, the second I frame of the multi-frame handover or assignment command message is sometimes not transferred to the mobile station—resulting in a dropped call. Ironically, the handover and assignment processes are usually triggered in part by deteriorating signaling conditions and retransmission of the first downlink I frame and subsequent acknowledgement during adverse channel conditions may extend the handover or assignment process, result in an L2 signaling failure, and eventually lead to a dropped call instead of a successful handover or assignment.

### BRIEF DESCRIPTION OF THE DRAWINGS

FIG. 1 shows a system diagram for a GSM network according to a system embodiment.

FIG. 2 shows a flow chart for a GSM base station implementing a multi-frame handover or assignment message method according to a base station embodiment.

FIG. 3 shows a flow chart for a GSM mobile station implementing a multi-frame handover or assignment message method according to a first mobile station embodiment.

FIG. 4 shows a flow chart for a GSM mobile station implementing a multi-frame handover or assignment message method according to a second mobile station embodiment.

### DETAILED DESCRIPTION OF THE EMBODIMENTS

A GSM serving base station transmits to a mobile station all the I frames of a multi-frame handover command message (or a multi-frame assignment command message) repeatedly in a cyclic manner, starting with the first I frame through the last I frame of the message. Transmission of the I frames of the final message are repeated in sequence continuously. If the base station receives any acknowledgements from the mobile station, the acknowledged I frames are removed from the cyclic repetitious transmission. The mobile station can either follow normal procedures for a multi-framing operation or it can buffer any out-of-sequence I frames received (either in sequence or in order of receipt) and re-assemble the complete final message after all I frames have been received.

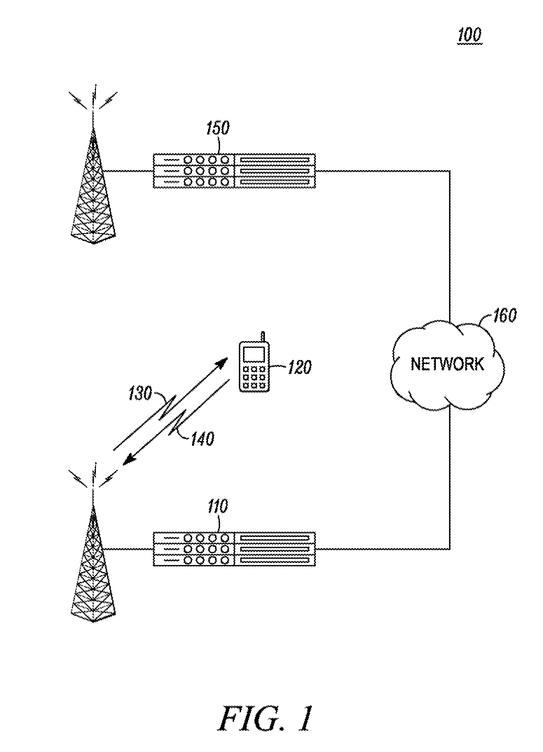

FIG. 1 shows a system diagram 100 for a GSM network according to a system embodiment. Although a current GSM network is envisioned here, past and future variations on the current GSM network are also within the scope of this system diagram 100. In this embodiment, a mobile station 120 compatible with a GSM network 160 is communicating with a serving base station 110 using uplink wireless signals 140. The serving base station 110 wirelessly communicates with the mobile station 120 using downlink wireless signals 130. Due to the geographic coverage of the serving base station 110 and the location of the mobile station 120, the base station 110 here seeks to hand over the communication traffic channel to another base station 150 using a Layer 3 handover command message (for an intercell handover) or a Layer 3 assignment command message (for an intracell handover).

During the handover or assignment process, the serving base station 110 transfers a final message on a data link before the data link is released. The serving base station 110 sends the final message to the mobile station 120 on a downlink control channel, such as an SDCCH (stand-alone dedicated control channel) or an FACCH (fast associated control channel), with a Service Access Point Identifier (SAPI) equal to 0. This final message is a multi-frame handover command message or an assignment command message containing information needed by the mobile station for a successful handover or assignment, such as a hopping list for the new base station 150, adaptive multi-rate (AMR) parameters, and/or other information as specified in the current 3GPP TS 44.018 Section 9.1.15. Although 3GPP TS 04.06 Section 5.8.4 limits k to 1 for SAPI=0 messages, in this situation k will be increased to a number between 2 and 7 at the base station 110. The value k represents the maximum number of sequentially numbered I frames that may be transmitted in an unacknowledged mode according to 3GPP TS 04.06 Section 5.8.4. In this embodiment, due to an existing GSM restriction of 3 bits for the k address, the final message has at most 7 frames (the largest value represented by 3 bits). In other embodiments without this restriction, k can have other maximum values.

With a value of k from 2 to 7, the serving base station 110 can transmit a multi-frame handover or assignment message up to seven frames long before requiring an acknowledgement from the mobile station 120. From some points of view, this may be characterized as placing the serving base station in an unacknowledged mode while the handover or assignment message is being transmitted. This might lead one to consider using a pure unacknowledged mode for the transmission of a final message; however, unacknowledged mode would not be compatible with existing mobile stations. From other points of view, an acknowledgement of the final message can be considered either a received uplink acknowledgement of all the downlink I frames of the final message (in either one acknowledgement message or multiple acknowledgement messages) or the mobile station appearing on the target channel and properly establishing a new data link connection.

Depending on the programming in the mobile station 120, the mobile station 120 can either receive and acknowledge the final message one I frame at a time in sequence (e.g., “legacy” mobile stations fully compliant with 3GPP TS 04.06 Section 5.7.1) or receive I frames out of sequence and acknowledge received I frames one or more at a time (e.g., “non-legacy” mobile stations).

By continuing to transmit further I frames in a multi-frame handover or assignment message without waiting to receive uplink I frame acknowledgements, the speed of the downlink transmission of the full handover or assignment message is increased. In poor uplink conditions but adequate downlink conditions, where the mobile station receives I frames of the final message but the mobile station's acknowledgement of each downlink I frame is not received by the base station, there is an increased probability of completing the handover because the mobile station's acknowledgements are no longer critical to the transmission of the complete multi-frame handover or assignment message. Additionally, the transmission of the complete multi-frame handover or assignment message is not hindered by retransmissions of I frames that were received by the mobile station but where the acknowledgement was not received by the base station.

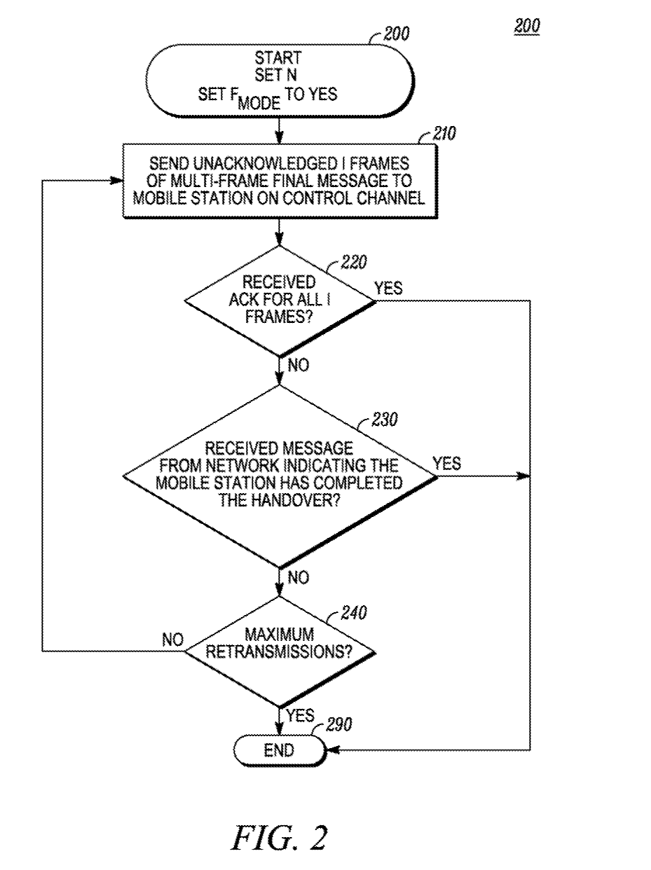

FIG. 2 shows a flow chart 200 for a GSM base station implementing a multi-frame handover or assignment message method according to a serving base station embodiment. The GSM base station implementing this flow chart 200 could be the serving base station 110 shown in FIG. 1. In step 200, the handover process starts. In this implementation, the base station formulates the handover or assignment message, sets the number of frames N of the handover message that will be sent without receiving acknowledgements to a number greater than 1, and sets a Final Mode (Fmode) bit to 1 (YES). Setting an Fmode bit to 1 indicates to the mobile station that this is the final message from the serving base station to be transferred in multi-framing mode on SAPI 0. In this implementation, N is equal to the number of I frames in the complete handover message. Due to existing constraints in the GSM system, N=<7 in this embodiment.

In the first pass through step 210, the serving base station transmits the first N I frames of the final message to a mobile station (such as mobile station 120 shown in FIG. 1) on a downlink control channel such as SDDCH or FACCH. This is because none of the I frames of the final message have been acknowledged at this point in time. It is assumed that the I frames are transmitted in received I frame sequence order, such as receive state variable V(R) sequence; however, out-of-sequence transmission is also possible. If there are 7 or fewer I frames in the handover or assignment message, then the base station can transmit the entire handover message without violating the other GSM constraints. The final message generally includes information such as frequency list, multi-rate parameters, and/or other parameters listed in 3GPP TS 44.018 Section 9.1.15.

Step 220 determines whether the base station has received an acknowledgement from the mobile station for all the I frames sent in step 210. When handing over mobile stations that send an acknowledgement for every I frame successfully received in full compliance with 3GPP TS 04.06 Section 5.7.1, the base station should receive one acknowledgement message for each I frame transmitted but any type of message indicating successful receipt of the complete final message by the mobile station is acceptable.

When handing over mobile stations that send cumulative acknowledgements, the base station receives at least one acknowledgement that includes the acknowledgement of the last I frame in the multi-frame handover or assignment command message that was transmitted by the base station (which implies an acknowledgement of all previous I frames in the message). Other acknowledgement schemes may be implemented, as long as the one or more received acknowledgement messages indicate to the base station that all the I frames transmitted in step 210 were received by the mobile station. If the appropriate acknowledgement message(s) have been received, then the base station knows that the mobile station has successfully received the multi-frame handover or assignment message and the process ends in step 290. If the handover or assignment message is greater than N frames long, the flow chart 200 may begin again with the next grouping of frames being sent in step 210.

If the N frames sent in step 210 have not all been acknowledged according to step 220, step 230 determines if the base station has received a message from the network (such as network 160 shown in FIG. 1) indicating that the mobile station has completed the handover or assignment. In this situation, another base station (such as base station 150 shown in FIG. 1) will become the new serving base station, and the new serving base station 150 will provide feedback to the previous base station 110 through the network 160. A completed handover or assignment is also an indicator that the mobile station has successfully received the complete multi-frame handover or assignment message, and the process ends in step 290.

If a handover has not been completed according to step 230, step 240 determines if a maximum number of retransmissions has occurred. According to 3GPP TS 04.06 Section 5.8.2, a retransmission counter N200 for data links with SAPI=0 is dependent on the control channel used. In the case of SDCCH, N200 is 23, and in the case of FACCH, N200 is set to 34 for full rate and 29 for half rate. If the retransmission counter N200 has not elapsed, the base station returns to step 210 and resends unacknowledged I frames of the final message to the mobile station. (In a variation on this embodiment, the base station resends the entire final message rather than only the unacknowledged I frames.) If the counter N200 has elapsed, the process ends in step 290 without the base station receiving any feedback that the mobile station has successfully received the multi-frame handover or assignment message.

If the timeout occurs according to step 240, there is a possibility that the call will dropped; however, using flow chart 200 decreases the probability of dropped calls relative to previous techniques, where each I frame of a SAPI=0 message must first be acknowledged before a next I frame can be sent.

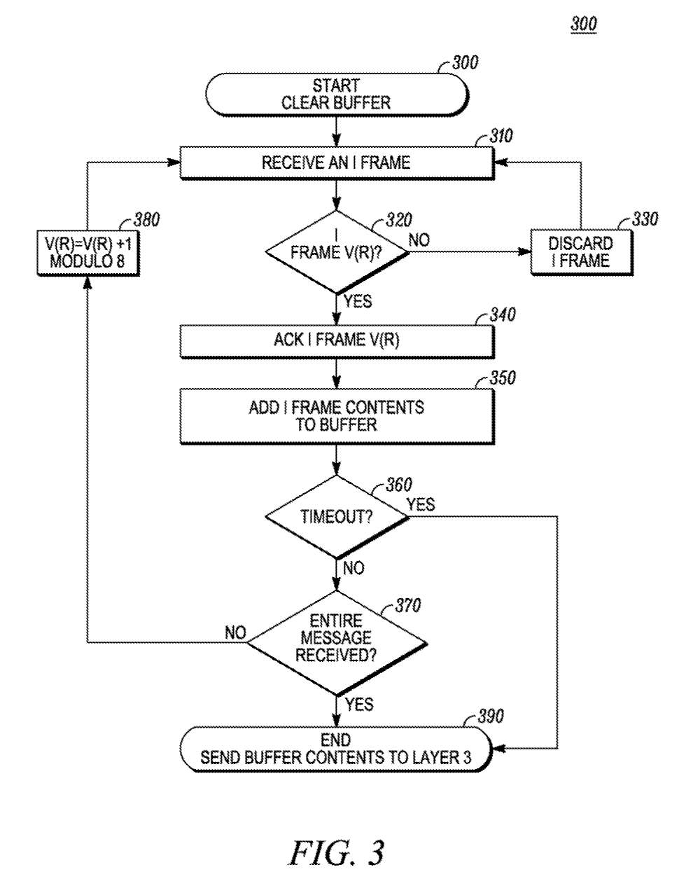

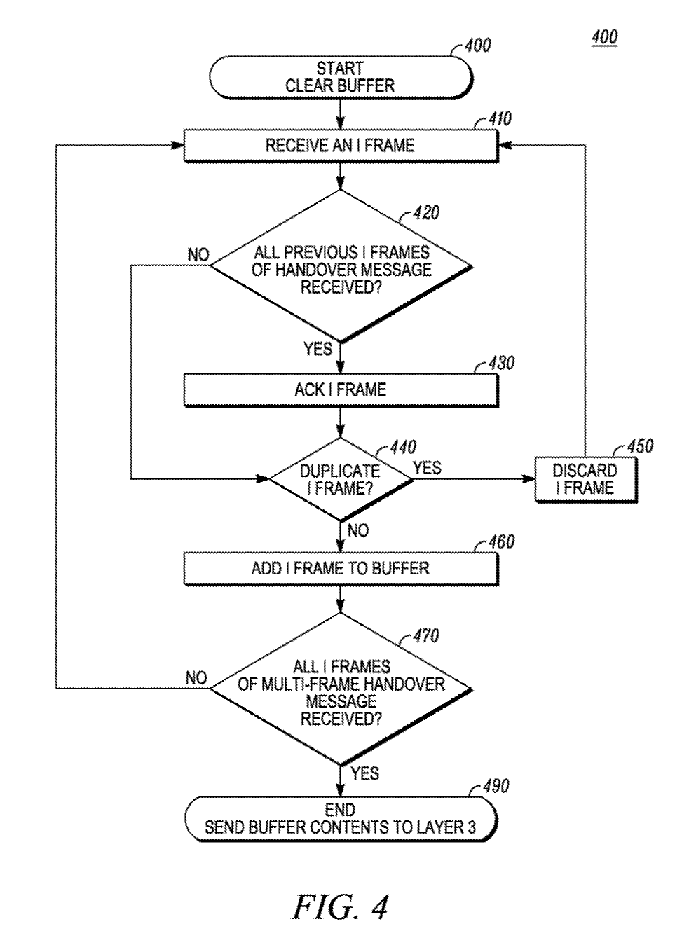

In order to better understand the effect of flow chart 200, FIG. 3 shows a flow chart 300 for a “legacy” mobile station that is fully compliant with 3GPP TS 04.06 Section 5.7.1 and FIG. 4 shows a flow chart 400 for a “non-legacy” mobile station that accepts I frames of a message out of sequence.

FIG. 3 shows a flow chart 300 for a GSM mobile station implementing a multi-frame handover or assignment message method according to a first mobile station embodiment. The GSM mobile station implementing this flow chart 300 could be the mobile station 120 shown in FIG. 1. In this first mobile station embodiment, the mobile station is fully compliant with 3GPP TS 04.06 Section 5.7.1 and capable of receiving one I frame of a multi-frame message at a time, in proper sequence, and capable of buffering the received I frames, in order of receipt, to create a complete handover or assignment message for Layer 3 processing.

In the start step 300, the buffer is cleared. Existing GSM mechanisms determine the receive state variable V(R) of the next I frame to be received (in a modulo 8 manner) and whether there are additional I frames in the final message. In a GSM system, there is a flag M in the message header where M=1 indicates that there are more I frames in the message and where M=0 indicates the last I frame in the message. Note that this implementation uses a k=1 windowing scheme in compliance with 3GPP TS 04.06 Section 5.8.4. In this k=1 windowing scheme, the mobile station acknowledges every I frame in sequence and does not acknowledge another I frame until the previous sequential I frame has been acknowledged. Also, any I frames that arrive at the mobile station out of order are discarded by the mobile station in accordance with 3GPP TS 04.06 Section 5.7.1.

In step 310, an I frame of a handover message is received from a serving base station on a downlink control channel such as SDCCH or FACCH. Step 320 determines if the received I frame is sequentially the next I frame expected in the final message. This embodiment contemplates the receive state variable V(R) scheme with modulo 8 arithmetic as described in 3GPP TS 04.06 Section 3.5.2.5; however, other sequencing methods can be used. If the received I frame is not the expected I frame according to frame sequence, step 330 discards the received I frame and returns to step 310. If the received I frame has the expected frame sequence information, then step 340 causes the mobile station to send a message acknowledging the I frame. Step 350 concatenates the received I frame contents within the buffer. Assuming that no timeout has occurred as determined by step 360, step 370 checks whether the entire handover or assignment message has been received, for example by noting if M=0. If the entire final message has not been received, step 380 increments the count for the expected next I frame and returns to step 310 to receive another I frame.

Subsequent passes through the flow chart 300 build up the received handover message in the buffer, one I frame at a time in sequence as long as a timeout has not occurred. If step 370 determines that the final I frame of the handover or assignment message has been received, this implies that the buffer contains the entire handover or assignment message, and step 390 passes the complete final message in the buffer to Layer 3 for processing by the mobile station.

In a handover or assignment situation with a robust downlink, the interaction of flow chart 200 implemented in a serving base station and flow chart 300 implemented in a served mobile station would promote the speed at which handover message I frames are transmitted from the serving base station to the mobile station, because flow chart 200 does not require a receipt of an acknowledgement message to send a next I frame. Thus, a multi-frame handover or assignment message is transmitted without regard to whether each I frame of the final message is acknowledged to the base station.

Under current multi-frame acknowledgement procedures, each I frame of the final message must be received in order. If the first I frame, for example, is not received by the mobile station due to a temporary downlink failure but all subsequent I frames are received by the mobile station, the base station cycles through transmission of the complete handover message in step 210, finds that no acknowledgement has been received per step 220 interacting with step 320 and 330 for each received I frame (in light of the failure to receive the first I frame), and also finds that the mobile station has not completed the handover. If the maximum number of retransmissions has not been reached, the flow in FIG. 2 returns to step 210 and the entire final message is retransmitted. In a second mobile station embodiment, the entire final message does not need to be retransmitted if a mobile station can buffer and acknowledge I frames received out of order.

In some implementations where Repeated RAACH is employed, each I frame is sent twice before stepping to the next I frame to increase the chances of reception by the mobile station. When downlink signaling is not robust, the repeated I frame is either ignored or combined with the first occurrence of the I frame. For the purposes of this discussion, the double I frame will be considered a single transmission and does not alter the basic steps in this embodiment.

FIG. 4 shows a flow chart 400 for a GSM mobile station implementing a multi-frame handover or assignment message method according to a second mobile station embodiment. In this second mobile station embodiment, the mobile station is capable of receiving I frames of a multi-frame message out of sequence, buffering them, and correctly ordering them to create a complete handover or assignment message for Layer 3 processing. In this embodiment, the mobile station is fully compliant with 3GPP TS 04.06 Section 5.8.4 and acknowledges each received I frame, but the mobile station is not fully compliant with 3GPP TS 04.06 Section 5.7.1 and discards only duplicate received I frames rather than discarding any I frame received out of sequence.

In the start step 400, the buffer is cleared. In step 410, an I frame is received by the mobile station. Step 420 determines if all previous I frames (if any) of the handover or assignment message have been received. If all previous I frames have been received, then step 430 acknowledges the I frame received in step 410. For example, if the I frame received in step 410 is the first I frame of a handover message, then there are no previous I frames to receive and the mobile station acknowledges the first I frame of the handover message in step 430. If the I frame received in step 410 is the second I frame of a handover message and the first I frame was not previously been received, then the second I frame is not acknowledged and the flow goes directly to step 440.

Step 440 checks if the I frame received in step 410 is a duplicate of any I frames of the handover or assignment message previously received. If the newest I frame is a duplicate, step 450 discards the I frame and returns to step 410. If the newest I frame is not a duplicate, step 460 adds the I frame contents to the buffer.

When step 470 determines that all the I frames of the handover or assignment message have been received, step 490 sends the buffer contents to Layer 3 for further processing. In this embodiment, the contents of the buffer are properly sequenced in step 490 after all the I frames have been received. In an alternate embodiment, the contents of the buffer can be correctly sequenced in step 460 when I frames are being added. If not all the I frames of the handover or assignment message have been received, the flow returns to step 410 to receive additional I frames. Further passes through the flow chart 400 continue to build up the complete handover message. The multiple I frames that make up the handover message can be received out of sequence, acknowledged (as appropriate), buffered, and correctly sequenced to create a complete handover message for Layer 3 processing.

Note that this implementation uses a cumulative acknowledgement scheme. In the cumulative acknowledgement scheme, an acknowledgement of a particular I frame of a message (e.g., I frame 3) indicates that all previous I frames of the message (e.g., I frame 1 and I frame 2) have also been successfully received. For example, if I frame 2 were the first I frame received, then no acknowledgement is sent. If I frame 1 were the next I frame received, then an acknowledgement of I frame 2 is sent (which implicitly acknowledges I frame 1). If I frame 3 were the third I frame received, then the acknowledgement of I frame 3 implies that both I frame 1 and I frame 2 were also successfully received. It is possible to use other types of acknowledgement schemes, such as explicitly acknowledging each I frame or another type of cumulative acknowledgement scheme, in place of this particular cumulative acknowledgement scheme.

The interaction of flow chart 400 and flow chart 200 mitigates the issue when, if an I frame of the handover message is not received or is received out of sequence, then the base station might need to retransmit the entire handover message before the mobile station can continue building the complete handover message. Flow chart 400 maintains the speed of the transmission of the handover message compared to flow chart 300, especially in robust downlink situations.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms, such as first and second, are used to distinguish one from another entity, item, or action without necessarily requiring or implying any actual such relationship or order between such entities, items, or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, is limited in the interest of brevity and minimization of any risk of obscuring the principles and concepts according to the present invention.

As understood by those in the art, mobile station and base stations include processors that execute computer program code to implement the methods described herein. Embodiments include computer program code containing instructions embodied in tangible media, such as floppy diskettes, CD-ROMs, hard drives, or any other computer-readable storage medium, wherein, when the computer program code is loaded into and executed by a processor, the processor becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

We claim:

1. A method of transmitting multi-frame handover or assignment messages to a mobile station comprising:
transmitting N I frames of a final message from a base station, where N is greater than 1; and
re-transmitting up to N I frames of the final message from the base station, if acknowledgement for N I frames of the final message has not been received by the base station.

2. A method according to claim 1 further comprising:
re-transmitting up to N I frames of the final message from the base station, if the base station has not received a message from a network indicating that the mobile station has completed a handover.

3. A method according to claim 1 further comprising:
re-transmitting up to N I frames of the final message from the base station, if a maximum number of retransmissions has not occurred.

4. A method according to claim 1 wherein N is less than 8.

5. A method according to claim 1 wherein the final message comprises a set of I frames, wherein the set of I frames consists of N I frames.

6. A method according to claim 1 wherein the final message comprises at least one of:
a frequency list and a multi-rate parameter.

7. A method according to claim 1 further comprising:
re-transmitting only I frames of the final message for which acknowledgement has not been received by the base station.

8. A method according to claim 1 further comprising:
entering a Final mode (Fmode) for suspending a requirement for receiving acknowledgement for each I frame of a final message transmitted on a data link having a Service Access Point Identifier (SAPI)=0.

9. A method according to claim 1 wherein transmitting sends each I frame twice.

10. A method of receiving multi-frame handover or assignment messages comprising:
receiving an I frame of a multi-frame final message having a received I frame sequence number;
transmitting an acknowledgment message for the I frame, if all I frames of the multi-frame final message having I frame sequence numbers previous to the received I frame sequence number have been received; and
adding contents of the I frame to a buffer.

11. A method according to claim 10 wherein adding the I frame contents to a buffer inserts contents of the I frame in I frame sequence.

12. A method according to claim 10 further comprising:
sending contents of the buffer to Layer 3.

13. A method according to claim 12 wherein the sending comprises:
ordering contents of the buffer in I frame sequence.

14. A method of receiving multi-frame handover or assignment messages comprising:
receiving an I frame of a multi-frame final message having a receive state variable;
transmitting an acknowledgment message for an I frame having a greatest receive state variable when I frames of the multi-frame final message having all receive state variables less than the greatest receive state variable have been received; and
adding contents of the I frame to a buffer.

15. A method according to claim 14 wherein the receive state variable is determined using modulo arithmetic.

16. A method according to claim 15 wherein receive state variable is determined using modulo 8 arithmetic.

17. A method of transmitting multi-frame handover or assignment messages comprising:
transmitting a first I frame of a final message from a base station;
transmitting a second I frame of a final message from a base station; and
receiving acknowledgement for the first I frame and the second I frame of the final message.

18. A method according to claim 17 comprising:
wherein the first I frame has a ‘more frames’ value M=1;
wherein the second I frame has a ‘more frames’ value M=0;
re-transmitting the first I frame if acknowledgement for the first I frame is not received; and
re-transmitting the second I frame if acknowledgement for the second I frame is not received.
